(19) United States
(12) Patent Application Publication
(10) Pub. No.: US 2010/0247756 A1
(43) Pub. Date: Sep. 30, 2010

(54) Method for forming lenticular prints

(75) Inventors: Seiichi Inoue, Kanagawa-ken (JP); Kazuaki Okamori, Kanagawa-ken (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/659,771

(22) Filed: Mar. 22, 2010

(30) Foreign Application Priority Data
Mar. 24, 2009 (JP) 2009-071186

(51) Int. Cl. B05D 5/06

(52) U.S. Cl. 427/162

(57) ABSTRACT

A lenticular print that allows stereoscopic viewing is formed by forming lenticular lenses, each having a convex sectional shape, on an image-recorded member, which has groups of parallax images arranged and written thereon. Each group of parallax images includes strips of parallax images. The lenticular lenses are formed correspondingly to the individual groups of parallax images. The lenticular print is formed through a base forming step of forming bases, which extend in a longitudinal direction of the parallax images and have a rectangular sectional shape and a predetermined height, of the lenticular lenses by depositing a transparent material on the groups of parallax images, and a lens forming step of forming lens top portions of the lenticular lenses by depositing the transparent material on the bases so that the deposited transparent material bulges upward from the bases due to surface tension thereof to have a substantially circular sectional shape.

### BACKGROUND OF THE INVENTION

1. Field of the Invention

The present invention relates to a method for forming lenticular prints, which allow stereoscopic viewing, by forming lenticular lenses on an image-recorded member which has groups of parallax images, each including strips of parallax images, arranged and written thereon.

2. Description of the Related Art

It has been known that stereoscopic viewing using parallax can be achieved by combining more than one images and three-dimensionally displaying the combined image. Such stereoscopic viewing can be achieved by photographing the same subject with more than one cameras placed at different positions to acquire more than one images of the subject having a parallax therebetween (which are hereinafter referred to as parallax images), and three-dimensionally displaying the parallax images with utilizing a parallax between the subject images contained in the parallax images.

As a technique for three-dimensionally displaying such images, a lenticular print has been known. The lenticular print is formed by preparing a lenticular sheet having an array of lenses (lenticular lenses), each lens having a convex cross section, and alternately arranging the parallax images cut into strips correspondingly to the individual lenticular lenses. A viewer of the thus formed lenticular print can stereoscopically view the image written as a lenticular print due to the parallax between the eyes.

In order to form such a lenticular print, a technique has been proposed, in which each group of parallax image strips is written within the width of each lenticular lens. Another technique for forming a lenticular print has been proposed, in which a melted transparent material is deposited using an inkjet system on an image-recorded member having groups of parallax image strips written thereon to form lenticular lenses correspondingly to the individual groups of parallax image strips (see Japanese Unexamined Patent Publication No. 2001-255606, which is hereinafter referred to as patent document 1). In the technique disclosed in patent document 1, the lenticular lenses are formed by depositing with an inkjet system a transparent resin on the image-recorded member so that the deposited transparent resin forming each lenticular lens has a substantially circular sectional shape due to surface tension of the transparent resin.

As shown in FIG. 23, each lenticular lens formed in the form of a lenticular sheet typically has a sectional shape formed by a rectangular portion 80 and a substantially circular portion 81 combined together. With such a sectional shape, light passed through the lenticular lens is focused on a parallax image 82 on the back side of the lenticular lens, thereby allowing stereoscopic viewing. However, when the technique disclosed in patent document 1 is used to form the lenticular lenses, each formed lenticular lens has a sectional shape that includes only the substantially circular portion 81, as shown in FIG. 24. Therefore, the transparent material forming the lenticular lens needs to have very high refractive index to focus the light passed through the lenticular lens on the parallax image 82 to allow successful stereoscopic viewing.

Further, with the technique disclosed in patent document 1, in which the melted transparent resin is deposited on the image-recorded member, in a case where the lenticular lenses are formed by forming layers of the transparent resin one on the other, it is necessary that an underlying (previously deposited) transparent resin layer has cured before the next transparent resin layer is deposited so that the next layer does not merge with the underlying transparent resin layer. In addition, even when the underlying layer has cured, the next deposited transparent resin may run down or spread when it is still wet, and therefore it is not easy to form the resin layers one on the other. Even in a case where each lenticular lens is formed by a single resin layer, if the deposited transparent resin spreads when it is still wet, adjacent lenticular lenses are connected to each other, as shown in FIG. 25, and the formed lenticular lenses fail to provide good separation between the parallax images and successful stereoscopic viewing.

### SUMMARY OF THE INVENTION

In view of the above-described circumstances, the present invention is directed to forming a lenticular print which allows successful stereoscopic viewing.

The method for forming a lenticular print according to the invention is a method for forming a lenticular print that allows stereoscopic viewing by forming lenticular lenses, each having a convex sectional shape, on an image-recorded member, the image-recorded member having groups of parallax images arranged and written thereon, each group of parallax images including strips of parallax images, and the lenticular lenses being formed at positions corresponding to the individual groups of parallax images. The method includes: a base forming step of forming bases of the lenticular lenses by depositing a transparent material on the groups of parallax images on the image-recorded member, the bases extending in a longitudinal direction of the parallax images and having a rectangular sectional shape and a predetermined height; and a lens forming step of forming lens top portions of the lenticular lenses by depositing the transparent material on the bases, the deposited transparent material bulging upward from the bases due to surface tension thereof to have a substantially circular sectional shape.

The “predetermined height” is determined with taking a focal length of the lenticular lenses to be formed into account, so that light passed through the lenticular lenses is focused on the parallax images written on the image-recorded member.

In the method for forming a lenticular print according to the invention, the base forming step may be carried out at different times for adjacent groups of the groups of parallax images, and the lens forming step may be carried out at different times for adjacent groups of the groups of parallax images.

In the method for forming a lenticular print according to the invention, the base forming step may include forming the bases by depositing the transparent material on the groups of parallax images with an inkjet head for base.

In the method for forming a lenticular print according to the invention, the base forming step may include: a depositing step of depositing the transparent material on the groups of parallax images with the inkjet head for base, the transparent material being curable; a curing step of curing the deposited transparent material; and a laminating step of forming the bases by repeating operations of depositing a predetermined deposition amount of the transparent material on the cured transparent material and curing the deposited transparent material, wherein the laminating step may include depositing the transparent material to satisfy a relationship pₘᵢₙ≦p, where p is a dot pitch of the transparent material to be deposited and pₘᵢₙ is a minimum dot pitch for ensuring that the deposited transparent material does not run off an edge of a landing-position transparent material, the landing-position transparent material being the transparent material cured at a landing position of the transparent material to be deposited.

In this case, the laminating step may include depositing the transparent material to satisfy a relationship p≦pₘₐₓ, where pₘₐₓ is a maximum dot pitch which is a jaggy limit (i.e., when the dot pitch exceeds the jaggy limit, jaggies are produced).

Further, in this case, the laminating step may include depositing the transparent material to satisfy a relationship pₘᵢₙ≦p+a, where “a” represents a landing accuracy of the transparent material to be deposited.

Furthermore, in this case, the laminating step may include determining the minimum dot pitch pₘᵢₙ based on the predetermined deposition amount and a sectional area of a pattern formed by the transparent material to be deposited.

Moreover, in this case, the laminating step may include calculating the sectional area based on a contact angle between the transparent material to be deposited and the landing-position transparent material.

Further, in this case, the transparent material may be a material that is curable when exposed to an electromagnetic wave including visible light or invisible light, the curing step may include curing the transparent material by exposing the transparent material to the electromagnetic wave, and the laminating step may include controlling the contact angle based on physical properties of the transparent material, as well as exposure time and exposure intensity of the exposure of the landing-position transparent material.

In addition, in this case, the laminating step may include calculating the sectional area according to the equation below:

$${S}_{n} = [ ( {φ}_{n - 1} + {θ}_{n} ) \frac{{d}_{n}}{2 sin ( {φ}_{n - 1} + {θ}_{n} )} - \{ \begin{matrix}( {φ}_{n - 2} + {θ}_{n - 1} ) \frac{{d}_{n - 1}}{2 sin ( {φ}_{n - 2} + {θ}_{n - 1} )} - \\ \frac{{d}_{n}}{4} ( \begin{matrix}\frac{{d}_{n - 1}}{tan ( {φ}_{n - 2} + {θ}_{n - 1} )} - \\ \frac{{d}_{n}}{tan ( {φ}_{n - 1} + {θ}_{n} )}\end{matrix} )\end{matrix} \} ]$$

where θₙ represents a contact angle between the transparent material to be deposited and the landing-position transparent material, θₙ₋₁ represents a contact angle between the landing-position transparent material and a substance on which the landing-position transparent material lands, Φₙ₋₁ represents an angle between a tangential line to the surface of the landing-position transparent material and a plane parallel to the surface of the image-recorded member at a tangent point between the surface of the transparent material to be deposited and the landing-position transparent material, Φₙ₋₂ represents an angle between a tangential line to the surface of the substance and a plane parallel to the surface of the image-recorded member at a tangent point between the landing-position transparent material and the substance on which the landing-position transparent material lands, and Sₙ represents the sectional area.

In the method for forming a lenticular print according to the invention, the inkjet head for base may be an inkjet head of an electrostatic concentration inkjet system.

In the method for forming a lenticular print according to the invention, the base forming step may include depositing the transparent material with moving the inkjet head for base and the image-recorded member relatively to each other in the longitudinal direction of the parallax images.

In the method for forming a lenticular print according to the invention, the base forming step may include using a same nozzle of the inkjet head for base to deposit the transparent material to form the bases corresponding to at least two adjacent lenticular lenses.

In the method for forming a lenticular print according to the invention, the lens forming step may include forming the lens top portions by depositing the transparent material on the bases with an inkjet head for lens top portion.

In the method for forming a lenticular print according to the invention, the lens forming step may include using a same nozzle of the inkjet head for lens top portion to deposit the transparent material to form the lens top portions corresponding to at least two adjacent lenticular lenses.

In the method for forming a lenticular print according to the invention, the bases may have a height equal to or greater than a radius of curvature of a portion of each lens top portion bulging upward from the base and having the substantially circular sectional shape. Specifically, the height of the bases may satisfy a relationship: height≧1/{(n−1)×(1/R)}−R, where n represents a refractive index of the transparent material, and R represents a radius of curvature at the lens top portion of each lenticular lens to be formed.

According to the present invention, first, the bases having a rectangular sectional shape and a predetermined height are formed, and then, the lens top portions of the lenticular lenses are formed on the bases. The presence of the bases ensures a distance from the portions of the lenticular lenses having the substantially circular sectional shape to the image-recorded member. Therefore, by setting an appropriate height of the bases, light passed through the formed lenticular lenses is focused on the image-recorded member, thereby allowing successful stereoscopic viewing of the lenticular print formed according to the invention.

Further, since the bases have a rectangular sectional shape, when the transparent material is deposited to form the lens top portions, the transparent material bulges upward to have a substantially circular sectional shape, due to the surface tension thereof, at rectangular corner portions present on the upper side of each base. This prevents the deposited transparent material from spreading when it is still wet and resulting in connected adjacent lenticular lenses.

Further, by carrying out the formation of the bases at different times for adjacent groups of the groups of parallax images and the formation of the lens top portions at different times for adjacent groups of the groups of parallax images, the transparent material deposited on the bases can be prevented from spreading when it is still wet and resulting in connected adjacent lenticular lenses.

Furthermore, by forming the bases by depositing the transparent material on the groups of parallax images with an inkjet head, efficient formation of the bases can be achieved.

Moreover, by depositing the transparent material to satisfy a relationship pₘᵢₙ≦p, where p is the dot pitch of the transparent material to be deposited and pₘᵢₙ is the minimum dot pitch which ensures that the deposited transparent material does not run off the edge of the cured landing-position transparent material at the landing position thereof, the transparent material can be deposited without spreading out from the area of the previously cured transparent material. This allows formation of the bases having a uniform thickness and a high aspect ratio.

Among various inkjet systems, the electrostatic inkjet system allows ejection of a concentrated solid content, and particles contained in the transparent material are self-assembled due to the liquid-bridging force when the solvent is dried off. Thus, the deposited transparent material can form layers without spreading when it is still wet. Therefore, the deposited transparent material can be prevented from spreading when it is still wet, thereby allowing accurate formation of the bases having a rectangular sectional shape.

Moreover, by depositing the transparent material with moving the inkjet head and the image-recorded member relatively to each other in the longitudinal direction of the parallax images, the bases can be formed continuously along the direction in which the bases are to be formed. This can prevent positional misalignment of the bases, thereby allowing more accurate formation of the bases.

Further, by using the same nozzle of the inkjet head to deposit the transparent material to form the bases corresponding to at least two adjacent lenticular lenses, the bases for forming the at least two adjacent lenticular lenses can be formed with the nozzle having the same characteristics. Thus, the adjacent lenses having the same characteristics can be provided, thereby allowing more successful stereoscopic viewing of the formed lenticular print.

By using the same nozzle of the inkjet head to deposit the transparent material to form the lens top portions corresponding to at least two adjacent lenticular lenses, the at least two adjacent lenticular lenses can be formed with the nozzle having the same characteristics. Thus, the adjacent lenticular lenses having the same characteristics can be provided, thereby allowing more successful stereoscopic viewing of the formed lenticular print.

By making the height of the bases greater or equal to the radius of curvature at a portion of each lens top portion bulging upward from the base and having the substantially circular sectional shape, an optical path length of light passed through the lenticular lenses can reliably be ensured. This allows more successful stereoscopic viewing of the lenticular print formed according to the invention.

### BRIEF DESCRIPTION OF THE DRAWINGS

FIG. 1 is a schematic perspective view illustrating the structure of an inkjet recording device used in a method for forming a lenticular print according to a first embodiment of the present invention,

FIG. 2 is a diagram illustrating the structure of a lenticular print,

FIG. 3 is a flow chart illustrating operation of the inkjet recording device during formation of bases in the first embodiment,

FIG. 4 is a diagram for explaining formation of a first layer,

FIG. 5 is a diagram illustrating a state where deposition of a transparent material of the first layer has been finished,

FIG. 6 is a diagram for explaining formation of a second layer,

FIG. 7 is a diagram illustrating a cured pattern of the second layer,

FIG. 8 is a diagram illustrating a state where the bases are alternately formed,

FIG. 9 is a flow chart illustrating operation of the inkjet recording device during formation of top portions of lenses in the first embodiment,

FIG. 10 is a diagram illustrating a state where the lenticular lenses are alternately formed,

FIG. 11 is a diagram illustrating a state where new bases are formed between previously formed bases and lens top portions,

FIG. 12 is a diagram illustrating a state where the bases and the lens top portions are formed at positions corresponding to all the groups of parallax images,

FIG. 13 is a graph showing a relationship between exposure time and contact angle,

FIG. 14 is a schematic diagram illustrating a sectional shape of a pattern formed by depositing a transparent material on an image-recorded member,

FIG. 15 is a schematic diagram illustrating a sectional shape of a pattern formed by further depositing the transparent material on a cured transparent material,

FIG. 16 is a schematic perspective view illustrating the structure of an inkjet recording device used in a method for forming a lenticular print according to a second embodiment of the invention,

FIG. 17 is a schematic sectional view illustrating the schematic structure of a first head of an electrostatic inkjet system,

FIG. 18 is a schematic perspective view illustrating the schematic structure of an individual electrode of the first head of the electrostatic inkjet system,

FIG. 19 is a diagram for explaining scanning by the first head in a third embodiment,

FIG. 20 is a diagram for explaining scanning by a second head in the third embodiment,

FIG. 21 is a diagram illustrating arrangement of nozzles,

FIG. 22 is a diagram for explaining rotation of the head,

FIG. 23 is a sectional view illustrating the structure of a lenticular print,

FIG. 24 is a sectional view illustrating the structure of a lenticular print formed according to a conventional technique, and

FIG. 25 is a sectional view illustrating another structure of a lenticular print formed according to a conventional technique.

### DESCRIPTION OF THE PREFERRED EMBODIMENTS

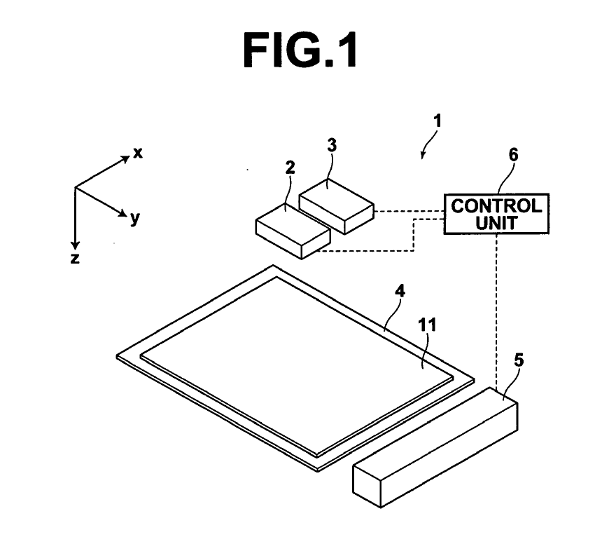

Hereinafter, embodiments of the present invention will be described with reference to the drawings. FIG. 1 is a schematic perspective view illustrating the structure of an inkjet recording device used in a method for forming a lenticular print according to a first embodiment of the invention. As shown in FIG. 1, the inkjet recording device 1 according to the first embodiment includes first and second inkjet heads (which may hereinafter simply be referred to as heads) 2 and 3, a support plate 4, an exposure mechanism 5, and a control unit 6.

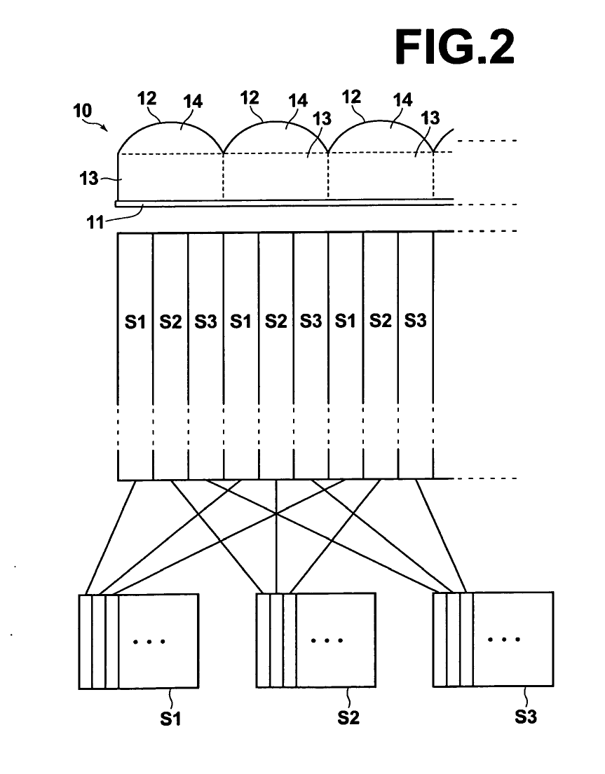

In the method for forming a lenticular print according to this embodiment, a transparent material is deposited on an image-recorded member, which has groups of parallax images (groups of parallax image strips) written thereon, to form lenticular lenses, thereby forming a lenticular print that allows stereoscopic viewing. FIG. 2 is a diagram illustrating the structure of the lenticular print formed in this embodiment. As shown in FIG. 2, the lenticular print 10 includes lenticular lenses (which may hereinafter simply be referred to as lenses) formed on an image-recorded member 11, and each lenticular lens includes a base 13 and a lens top portion 12. It should be noted that, on the image-recorded member 11 shown in FIG. 2, groups of parallax images, each including strips, which are cut along the vertical direction, at corresponding positions of three parallax images S1 to S3, for example, are alternately written. In this embodiment, the lenticular print 10 is formed by forming the lenses 12 correspondingly to the individual groups of parallax images.

Returning to FIG. 1, the first head 2 of the inkjet system deposits the transparent material on the image-recorded member 11 to form the bases 13 of the lenses 12. The second head 3 of the inkjet system deposits the transparent material on the bases 13 on the image-recorded member 11 to form the lens top portions 14. It should be noted that, although each of the first and second heads 2 and 3 in the first embodiment actually has one or more nozzles, this embodiment is explained with assuming that the material is ejected from one nozzle. Further, in this embodiment, the bases 13 are formed on the image-recorded member 11 by forming layers of the transparent material deposited from the first head 2.

As the transparent material forming the bases 13 and the lens top portions 14, any material can be used as long as it ensures adhesion to the image-recorded member 11, it does not spread over the image-recorded member 11 and the bases 13 when it is still wet, can form a lens shape having a substantially circular sectional shape by bulging upward from the bases 13 due to the surface tension, and has a predetermined refractive index and transparency when it has cured. The transparent material may be a light-curing material, which cures when exposed to light, such as, for example, a radically polymerizable or cationically polymerizable light-curing monomer. The transparent material may be a heat-curing material. The transparent material may be a hot-melt material, which is solid at the room temperature. In this case, the lenses 12 may be formed by depositing the transparent material on the image-recorded member 11 while the first and second heads 2 and 3 and the image-recorded member 11 are heated, and then curing the transparent material at the room temperature. The transparent material may be a material including transparent resin particles dispersed therein, which may be dried and hot melted after deposition. The transparent material may be a transparent resin solution, which may be dried after deposition. In the first embodiment, a light-curing transparent material is used. It should be noted that, in a case where the first head 2 is formed by an electrostatic inkjet head, as will be described later, the transparent material contains a charged particulate component.

The image-recorded member 11 with the groups of parallax images written thereon, as shown in FIG. 2, is fixed on the support plate 4. In this embodiment, the image-recorded member 11 is fixed on the support plate 4 with the longitudinal direction of the parallax images on the image-recorded member 11 being aligned with the x-direction shown in FIG. 1.

The first and second heads 2 and 3 and the support plate 4 are movable relatively to each other, and a positional relationship between them can be changed along the x-, y- and z-directions shown in FIG. 1. For this purpose, a moving means (not shown) for effecting relative movement between the heads 2 and 3 and the support plate 4 is provided in this embodiment. The moving means may be a head moving means for moving only the heads 2 and 3 in x-, y- and z-directions (which may be a combination of an x-direction moving means, a y-direction moving means and a z-direction moving means), or may be a support plate moving means for moving only the support plate 4 in x-, y- and z-directions (which may be a combination of an x-direction moving means, a y-direction moving means and a z-direction moving means). Alternatively, both a moving means for the heads 2 and 3 and a moving means for the support plate 4 may be provided. In this embodiment, a moving means for moving the heads 2 and 3 in the x- and z-directions and a moving means for moving the support plate 4 in the y-direction are provided.

It should be noted that the moving means for the support plate 4 may be a belt-conveying or drum-conveying moving means. Since the image-recorded member 11 with the lenses 12 formed thereon becomes stiffer, a belt-conveying moving means may be used to improve accuracy of through distance.

When the material is deposited, the position of the heads 2 and 3 in the z-direction is adjusted to provide a clearance between the support plate 4 and the heads 2 and 3 (i.e., a clearance between the surface of the image-recorded member 11 on the support plate 4 and the heads 2 and 3) of a predetermined value, and the clearance is maintained while the heads 2 and 3 are moved to scan in the x-direction. By depositing the material from the heads 2 and 3 on the image-recorded member 11 while the heads 2 and 3 are moved to scan in the x-direction, the bases 13 and the lens top portions 14 are formed on the image-recorded member 11. Further, by moving the heads 2 and 3 in the y-direction relatively to the image-recorded member 11, a deposition position of the material to be deposited on the image-recorded member 11 can be changed. The movement of the heads 2 and 3 and the movement of the support plate 4 are controlled by the control unit 6.

The exposure mechanism 5 is a light application mechanism with adjustable exposure intensity, which applies light to the image-recorded member 11 with the material deposited thereon from the heads 2 and 3 to achieve exposure of the deposited transparent material. The exposure mechanism 5 is disposed to cover an area across the support plate 4 in the x-direction shown in FIG. 1.

As the exposure mechanism 5, any light application mechanism that emits light to cure the transparent material may be used, and examples thereof include various light application mechanisms, such as metal halide lamp, high-pressure mercury lamp, LED, solid-state laser, gas laser and semiconductor laser. The light emitted by the exposure mechanism 5 may have any wavelength depending on the type of the material, and examples thereof include various types of light, such as ultraviolet light, visible light, infrared light and X-ray. Depending on the type of the material, a mechanism that applies an electromagnetic wave including any of various types of light and microwave may be used as the exposure mechanism. The intensity of the light (or electromagnetic wave) emitted by the exposure mechanism 5 can be controlled by changing intensity of the applied voltage, changing the type of a filter, or the like.

The first head 2 may be any of various types of inkjet heads, such as of a piezoelectric system using a piezoelectric device as an actuator, a thermal system using an electrothermal converter as an energy generating device, an electrostatic system using an electrostatic actuator, etc. In the first embodiment, a piezoelectric inkjet head is used, which has less constraint on the range of depositable materials.

The second head 3 may also be any of various types of inkjet heads, such as of a piezoelectric system, a thermal system or an electrostatic system. In the first embodiment, a piezoelectric inkjet head is used, which has less constraint on the range of depositable materials.

The control unit 6 controls operations of the first and second heads 2 and 3, the support plate 4 and the exposure mechanism 5. Specifically, the control unit 6 controls conveying speed, conveying distance and conveying timing of the support plate 4, and thus of image-recorded member 11, deposition amount and deposition timing of the transparent material, moving speed, moving distance and moving timing of the first and second heads 2 and 3, and light exposure intensity and exposure timing of the exposure mechanism 5, for example. Connection between the control unit 6 and the other components is not particularly limited as long as signal communication therebetween is provided, and may be wired or wireless connection.

Before actual operation to form the lenses 12 is begun, the control unit 6 calculates, for each layer, a deposition amount of the transparent material to be deposited from the first head 2, a dot pitch p, curing conditions of the deposited transparent material and the number of dots required for the entire width of one group of parallax images, as well as the number of layers to be formed, and stores the calculated information in a memory (not shown) of the control unit 6.

For the first layer, the deposition amount V of the transparent material to be deposited is calculated based on a contact angle θ₁ between the transparent material to be deposited and the image-recorded member 11, so that designed line width and height of the base 13 per scan are provided. Further, the dot pitch p is calculated such that the dot pitch does not exceed a maximum dot pitch pₘₐₓ, which is a jaggy limit (i.e., when the dot pitch exceeds the jaggy limit, jaggies are produced). It should be noted that, in this embodiment, the same deposition amount V of the transparent material to be deposited is applied to each scan and each layer.

For the n-th layer (n>2), a contact angle θₙ between the transparent material to be deposited and a previously cured transparent material on the image-recorded member 11, more precisely, a previously cured transparent material at a landing position of the transparent material to be deposited (hereinafter referred to as a “landing-position transparent material”) is calculated based on curing conditions (i.e., conveying speed, light intensity, etc., during exposure) of the landing-position transparent material and physical properties of the transparent material.

Then, based on the calculated contact angle θₙ and the shape of a pattern formed by the landing-position transparent material, a sectional area Sₙ of a pattern formed by the transparent material to be deposited when it lands on the landing-position transparent material is calculated. Then, the dot pitch p of the transparent material is calculated based on the sectional area Sₙ. The dot pitch p is calculated such that the dot pitch is not less than a minimum dot pitch pₘᵢₙ, which ensures that the transparent material to be deposited does not run off the edge of the landing-position transparent material, and the dot pitch does not exceed the maximum dot pitch pₘₐₓ, which is the jaggy limit.

Further, the curing conditions of the deposited transparent material are calculated so that an optimal contact angle is provided between the deposited transparent material and the next transparent material to be deposited on the deposited transparent material (such that, for example, a total angle of the contact angle plus an angle between the image-recorded member 11 and the surface of the deposited transparent material becomes 90 degrees).

The calculations of the contact angle θₙ, the sectional area Sₙ, the dot pitch p, and the curing conditions of the transparent material will be described later.

For the transparent material to be deposited from the second head 3, the deposition amount of the transparent material to be deposited, the dot pitch and the curing conditions of the deposited transparent material are calculated similarly to the above-described deposition amount of the transparent material to be deposited from first head 2, the dot pitch p and the curing conditions of the deposited transparent material.

The bases 13 are formed such that the height of each base is: height≧1/{(n−1)×(1/R)}−R, where n is a refractive index of the transparent material, and R is a radius of curvature at the top portion of each formed lens 12. The number of layers to be formed to form each base 13 is determined so that this height is provided.

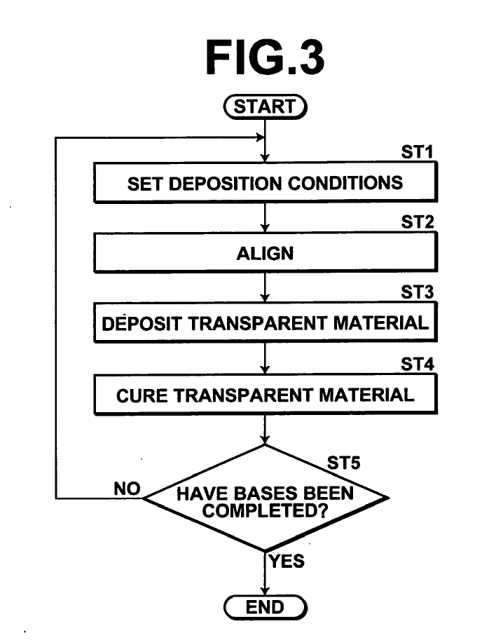

Now, operation of the inkjet recording device 1 according to the first embodiment is described. FIG. 3 is a flow chart illustrating the operation of the inkjet recording device during formation of the bases in the first embodiment. It is assumed here that the image-recorded member 11 with the parallax images written thereon is fixed at a predetermined position on the support plate 4, and the first head 2 is at an initial position before deposition of the material is started.

First, the control unit 6 reads out from the memory the information for the first layer, such as the ejection timing, the deposition amount V of the transparent material to be deposited, the dot pitch p and the curing conditions of the deposited transparent material, and sets deposition conditions of the transparent material (step ST1).

In this embodiment, each lens 12 to be formed on the image-recorded member 11 has a width of 127 μm. Therefore, the ejection timing, the deposition amount V of the transparent material to be deposited for the first layer, the number of dots required for the entire width and the number of layers to be formed are set to provide the base 13 having the width of 127 μm on the image-recorded member 11. Further, an ejection voltage waveform and a through distance (a distance from the nozzle forming surface of the head 2 to the surface of the image-recorded member 11 written with the parallax images) are set for the first head 2. For example, the ejection voltage waveform may be a 20 V rectangular wave, the through distance may be 1 mm, and an amount of ejected droplet may be 1 μl.

Subsequently, the first head 2 is aligned to a position on the image-recorded member 11 where the base 13 is to be formed (step ST2), and the transparent material is deposited on the image-recorded member 11 based on the set deposition conditions (step ST3).

Specifically, while the first head 2 is moved in the x-direction, the transparent material is deposited from the first head 2 onto a position on the image-recorded member 11 facing the first head 2. The transparent material is deposited from the first head 2 on the image-recorded member 11 according to the deposition amount V and the dot pitch p read out by the control unit 6.

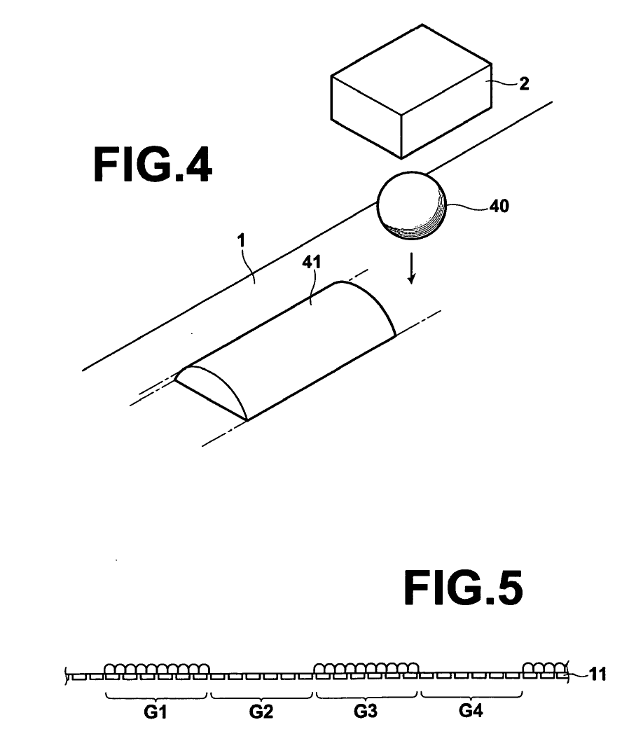

FIG. 4 is a diagram for explaining formation of the first layer. As shown in FIG. 4, a transparent material droplet 40 ejected from the head 2 lands on the image-recorded member 11 to form a pattern 41 of the first layer. The shape of the pattern is indicated by the chain lines in FIG. 4. The formed pattern has a barrel vault-like sectional shape, as shown in FIG. 4.

The control unit 6 moves the first head 2 across the image-recorded member 11 to deposit the transparent material across an area on the image-recorded member 11 facing the first head 2 being moved, and then moves the image-recorded member 11 in the y-direction by a distance corresponding to one dot of the deposited transparent material, so that head 2 can deposit the transparent material on a position adjacent to the previously deposited transparent material.

Then, the control unit 6 moves the first head 2 across the image-recorded member 11 again to deposit the transparent material across an area on the image-recorded member 11 facing the first head 2 being moved, and when the deposition is finished, the control unit 6 moves the image-recorded member 11 in the y-direction by a distance corresponding to one dot of the deposited transparent material.

In this manner, the deposition of the transparent material by the first head 2 and the movement of the image-recorded member 11 are repeated until the deposition of the transparent material within the width of one group of parallax images is finished. When the deposition of the transparent material within the width of the one group of parallax images has been finished, the deposition of the transparent material on the next one of the groups of parallax images, which is not directly adjacent to the previous group on which the transparent material has just been deposited, is carried out, in order to form the bases 13 on the adjacent groups of parallax images at different times. Specifically, the transparent material is deposited within the width of one group of parallax images, which is next to the group of parallax images directly adjacent to the previous group on which the transparent material has, just been deposited. In this manner, the transparent material is deposited alternately on the every other group of parallax images. The control unit 6 repeats the above described operations to deposit the transparent material alternately on the every other group of parallax images throughout the image recorded member 11.

FIG. 5 is a diagram illustrating a state where the deposition of the transparent material of the first layer has been finished. The image recorded member 11 shown in FIG. 5 has groups of parallax images G1 to G4, each including six parallax images (parallax image strips), written thereon. In the state where deposition of the transparent material of the first layer has been finished, as shown in FIG. 5, the transparent material is deposited only within the widths of the groups of parallax images G1 and G3 among the four groups of parallax images G1 to G4. It should be noted that, in FIG. 5, dots of the deposited transparent material are shown for convenience of explanation; however, actually, the dots of transparent material deposited adjacent to each other form continuous bodies of the transparent material on the groups of parallax images G1 and G2.

After the transparent material has been deposited throughout the image-recorded member 11, the control unit 6 causes the transparent material deposited on the image-recorded member 11 to be cured (step ST4). Specifically, the image-recorded member 11 is conveyed to a position where the image-recorded member 11 faces the exposure mechanism 5. Then, light is applied from the exposure mechanism 5 to the image-recorded member 11 while the image-recorded member 11 is conveyed at a predetermined speed to cure the deposited transparent material. The conveying speed of the image-recorded member 11 and the intensity of the light applied from the exposure mechanism 5 are those set by the control unit 6. When the transparent material deposited on the image-recorded member 11 has been cured, determination is made as to whether or not formation of the bases 13 has been completed (step ST5).

If it is determined that the formation of the bases 13 has not been completed, that is, it is necessary to further deposit the transparent material to form another layer, the process returns to step ST1. If it is determined that the formation of the bases 13 has been completed, the process ends.

Since the above explanation is about the formation of the first layer, the process returns to step ST1 to carry out formation of the second layer. First, the control unit 6 reads out from the memory the information for the second layer (the n-th layer for the n-th time repetition (n>2)), such as the deposition amount V of the transparent material to be deposited, the dot pitch p and the curing conditions of the deposited transparent material, and sets the deposition conditions (step ST1).

Then, the control unit 6 returns the image-recorded member 11 to an initial position and aligns the first head 2 to a position on the image-recorded member 11 where the base 13 is to be formed (step ST2). Then, the transparent material is deposited on the image-recorded member 11 based on the set deposition conditions (step ST3). Specifically, while the first head 2 is moved, the transparent material is deposited from the first head 2 on the cured transparent material on the image-recorded member 11 according to the read out deposition amount V and dot pitch p.

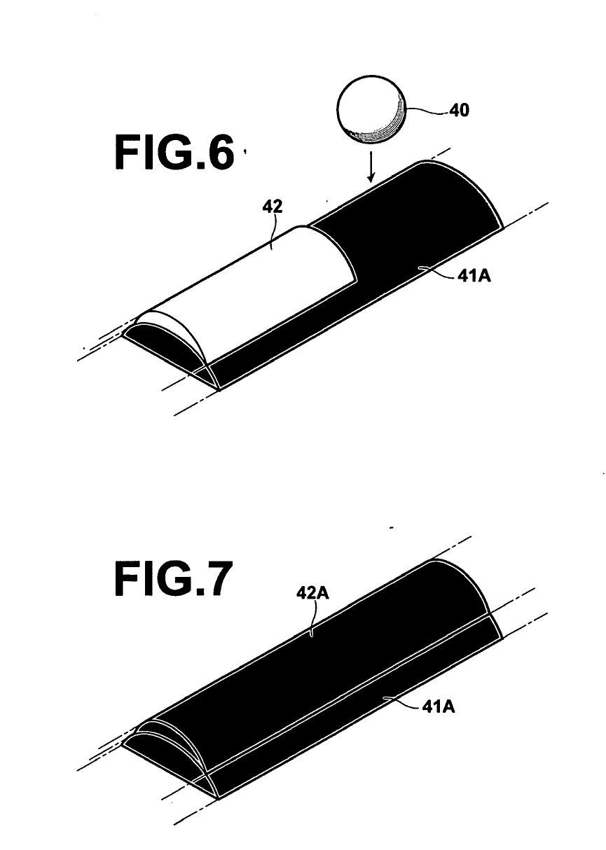

FIG. 6 is a diagram for explaining the formation of the second layer. As shown in FIG. 6, the transparent material droplet 40 ejected from the first head 2 lands on a pattern 41A of the cured first layer and forms a pattern 42 of the second layer. The shape of the pattern is indicated by the chain lines in FIG. 6. The formed pattern has a barrel vault-like sectional shape, as shown in FIG. 6. In FIG. 6, the first head 2 and the image-recorded member 11 are omitted.

Then, similarly to the first layer, the deposition of the transparent material by the first head 2 and the movement of the image-recorded member 11 by the distance corresponding to one dot of the deposited transparent material are repeated to deposit the transparent material over the entire area of the previously cured transparent material on the image-recorded member 11. Then, the transparent material deposited on the previously cured transparent material is cured (step ST4). Specifically, light is applied from the exposure mechanism 5 to the image-recorded member 11 while the image-recorded member 11 is conveyed at a predetermined speed to cure the deposited transparent material. The conveying speed of the image-recorded member 11 and the intensity of the light applied from the exposure mechanism 5 are those in the conditions set in step ST1. FIG. 7 shows the cured pattern of the second layer. As shown in FIG. 7, the cured pattern 42A of the second layer is formed on the cured pattern 41A of the first layer.

When the transparent material deposited on the image-recorded member 11 has been cured, determination is made as to whether or not formation of the bases 13 has been completed (step ST5). If it is determined that the formation of the bases 13 has not been completed, that is, it is necessary to further deposit the transparent material to form another layer, the process returns to step ST1 to set the deposition conditions for the next layer, and the steps of deposition and curing of the transparent material are repeated. If it is determined that the formation of the bases 13 has been completed, the process ends.

As described above, the inkjet recording device 1 repeats the deposition and curing of the transparent material to form layers of the cured transparent material, thereby forming the bases 13 alternately on every other group of parallax images on the image-recorded member 11.

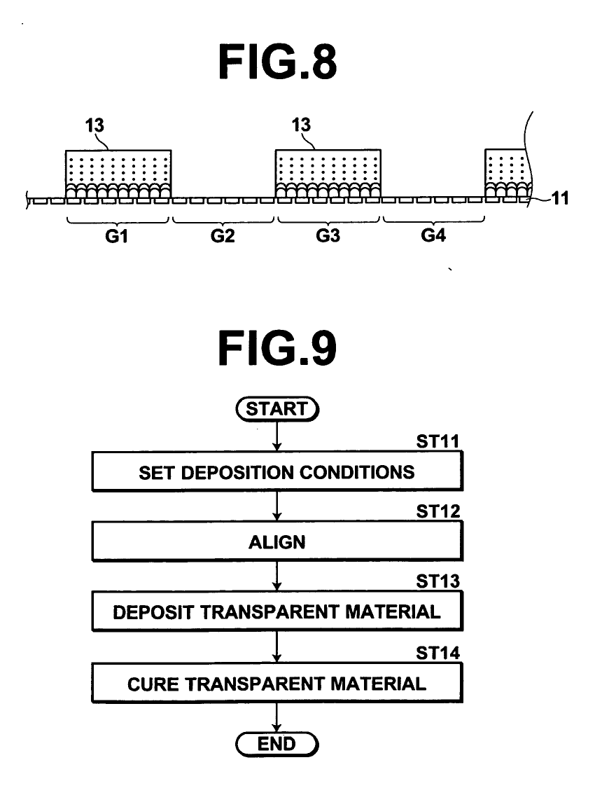

FIG. 8 shows a state where the bases are alternately formed. As shown in FIG. 8, among the four groups of parallax images G1 to G4 on the image-recorded member 11, the bases 13 are formed only within the widths of the groups of parallax images G1 and G3. After the bases 13 have been formed alternately on every other group of parallax images, the lens top portions 14 are formed.

Next, operation during formation of the lens top portions is described. FIG. 9 is a flow chart illustrating the operation of the inkjet recording device during formation of the lens top portions in the first embodiment. It is assumed here that the image-recorded member 11 with the bases 13 alternately formed thereon is fixed at a predetermined position on the support plate 4, and the second head 3 is at an initial position before deposition of the material is started.

First, the control unit 6 reads out from the memory the information, such as the ejection timing of the transparent material, the deposition amount of the material, the dot pitch, the curing conditions of the deposited transparent material, etc., and sets the deposition conditions of the transparent material (step ST11).

Then, the second head 3 is aligned to a position on the image-recorded member 11 where the lens top portion 14 is to be formed (step ST12), and the transparent material is deposited, based on the set deposition conditions, on the base 13 formed on the image-recorded member 11 (step ST13).

Specifically, while the second head 3 is moved in the x-direction, the transparent material is deposited from the second head 3 onto a position on the image-recorded member 11 facing the second head 3. The transparent material is deposited from the second head 3 only on a position on the base 13 on the image-recorded member 11, according to the deposition amount and the dot pitch read out by the control unit 6.

The control unit 6 moves the second head 3 across the image-recorded member 11 to deposit the transparent material across an area on the image-recorded member 11 facing the second head 3 being moved, and then moves the image-recorded member 11 by a predetermined distance in the y-direction so that the next position on the base 13 faces the second head 3.

Then, the control unit 6 moves the second head 3 across the image-recorded member 11 again to deposit the transparent material across an area on the image-recorded member 11 facing the second head 3 being moved, and when the deposition is finished, the control unit 6 moves the image-recorded member 11 by the predetermined distance in the y-direction so that the next position on the base 13 faces the second head 3.

In this manner, the deposition of the transparent material by the second head 3 and the movement of the image-recorded member 11 by the predetermined distance are repeated to deposit the transparent material at positions on the bases 13 throughout the image-recorded member 11. By depositing the transparent material in this manner, the presence of the bases 13 makes the transparent material bulge upward from the bases 13 due to the surface tension thereof, thereby providing a substantially circular sectional shape of the top portion of the transparent material corresponding to each lens.

After the transparent material has been deposited throughout the image-recorded member 11, the transparent material deposited on the image-recorded member 11 is cured (step ST14). Specifically, the image-recorded member 11 is conveyed to a position where the image-recorded member 11 faces the exposure mechanism 5. Then, light is applied from the exposure mechanism 5 to the image-recorded member 11 while the image-recorded member 11 is conveyed at a predetermined speed to cure the deposited transparent material. The conveying speed of the image-recorded member 11 and the intensity of the light applied from the exposure mechanism 5 are those set by the control unit 6. When the transparent material deposited on the image-recorded member 11 has been cured, the process ends. In this manner, the lenses 12 formed by the bases 13 and the lens top portions 14 are alternately formed on the image recorded member 11.

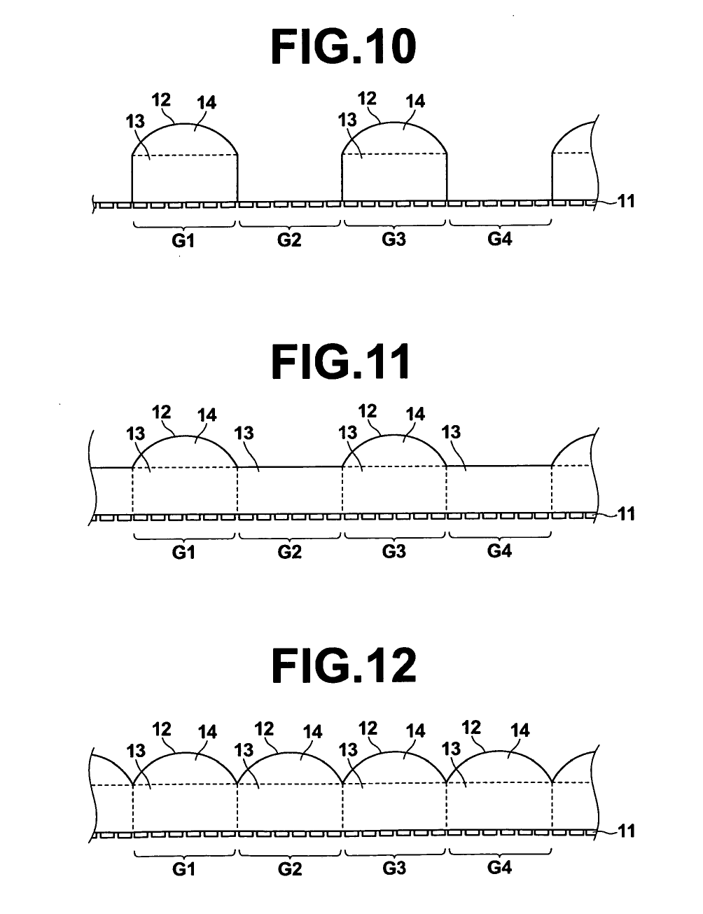

FIG. 10 shows a state where the lenses are alternately formed. As shown in FIG. 10, the lens top portions 14, each of which bulges upward due to the surface tension and has the substantially circular sectional shape, are formed on the bases 13 at positions corresponding to the groups of parallax images G1 and G3 on the image-recorded member 11, thereby forming the lenses 12.

Then, new bases 13 and new lens top portions 14 are formed between the previously formed lenses 12. Formation of the new bases 13 is achieved by repeating deposition of the transparent material from the first head 2 between the previously formed lenses 12 and curing of the deposited transparent material. In this manner, the new bases 13 are formed between the previously formed lenses 12; i.e., at positions corresponding to the groups of parallax images G2 and G4, as shown in FIG. 11. On the other hand, formation of the lens top portions 14 is achieved by deposition of the transparent material from the second head 3 on the newly formed bases 13 and curing of the deposited transparent material. In this manner, the lenses 12 formed by the bases 13 and the lens top portions 14 are formed on the positions corresponding to all the groups of parallax images G1 to G4, as shown in FIG. 12.

It should be noted that, although the lens top portions 14 are formed in the above example by depositing the transparent material once on each position, the lens top portions 14 may be formed by repeating deposition and curing of the transparent material to form layers of the transparent material one on the other, similarly to the formation of the bases 13.

As described above, in the first embodiment, the lenses 12 are formed by forming the bases 13 first, and then forming the lens top portions 14 on the bases 13. Therefore, a distance between the portions of the lenses 12 having the substantially circular sectional shape to the image-recorded member 11 can be ensured with the bases 13. By setting an appropriate height of the bases 13, the light passed through the formed lenses 12 is focused on the image-recorded member 11, thereby allowing successful stereoscopic viewing of the lenticular print formed according to this embodiment.

Further, since the bases 13 have a rectangular sectional shape, when the transparent material is deposited to form the lens top portions 14, the transparent material bulges upward to have the substantially circular sectional shape due to the surface tension thereof at the rectangular corner portions of each base. The deposited transparent material can thus be prevented from spreading when it is still wet and resulting in connected adjacent lenses 12.

Moreover, by carrying out the formation of the base 13 at different times on adjacent groups of the groups of parallax images and the formation of the lens top portions 14 at different times on adjacent groups of the groups of parallax images, the transparent material deposited on the bases 13 to form the lens top portions 14 can be prevented from spreading when it is still wet and resulting in connected adjacent lenses 12.

Furthermore, by depositing the transparent material to satisfy the relationship pₘᵢₙ≦p, where p is the dot pitch of the transparent material to be deposited and pₘᵢₙ is the minimum dot pitch which ensures that the transparent material to be deposited does not run off the edge of the cured landing-position transparent material at the landing position of the transparent material to be deposited, the transparent material can be deposited without spreading out from the area of the previously cured transparent material. This allows formation of the bases 13 having a uniform thickness and a high aspect ratio.

Moreover, by setting the height of the bases 13 larger than the radius of curvature of the portion of each lens bulging upward from the bases 13 and having the substantially circular sectional shape, an optical path length of the light passed through the lenses 12 can reliably be ensured, thereby allowing more successful stereoscopic viewing of the lenticular print formed according to this embodiment.

In addition, efficient formation of the bases 13 can be achieved by depositing the transparent material on the groups of parallax images using an inkjet system.

Now, one example of calculation of the dot pitch p for depositing the transparent material in the first embodiment is described in detail. To calculate the dot pitch p, it is necessary to know the contact angle θₙ between the transparent material to be deposited and the previously cured transparent material at the landing position of the transparent material to be deposited. Therefore, first, calculation of the contact angle θₙ is described.

The control unit 6 stores correspondence relationships between the contact angle θₙ, physical properties (such as composition, viscosity, etc.) of the transparent material to be deposited, physical properties of the transparent material cured on the image-recorded member 11, and degrees of curing of the transparent material, which have been calculated in advance through experiments, etc. The control unit 6 calculates the physical properties of the transparent material based on the type of the cured transparent material and the type of the transparent material to be deposited. The control unit 6 further calculates the degree of curing of the cured transparent material based on the exposure conditions (i.e., the conveying speed, the intensity of light, etc.) during exposure by the exposure mechanism 5. Then, the control unit 6 calculates the contact angle θₙ between the transparent material to be deposited and the previously cured transparent material at the landing position of the transparent material to be deposited based on the results of the calculations and the stored correspondence relationships.

Next, calculation of the correspondence relationship between the degree of curing of the transparent material and the contact angle θₙ, which is stored in advance in the control unit 6, is described. First, the transparent material is applied over the entire surface of the image-recorded member 11 by bar coating, and then is exposed to light by the exposure mechanism for a predetermined time to prepare a cured film sample of the transparent material. Then, the transparent material is further deposited on the cured film sample of the transparent material.

Then, the contact angle between the deposited transparent material and the cured film sample of the transparent material is measured. Further, the above measurement is carried out for various exposure times by changing only the time of exposure by the exposure mechanism.

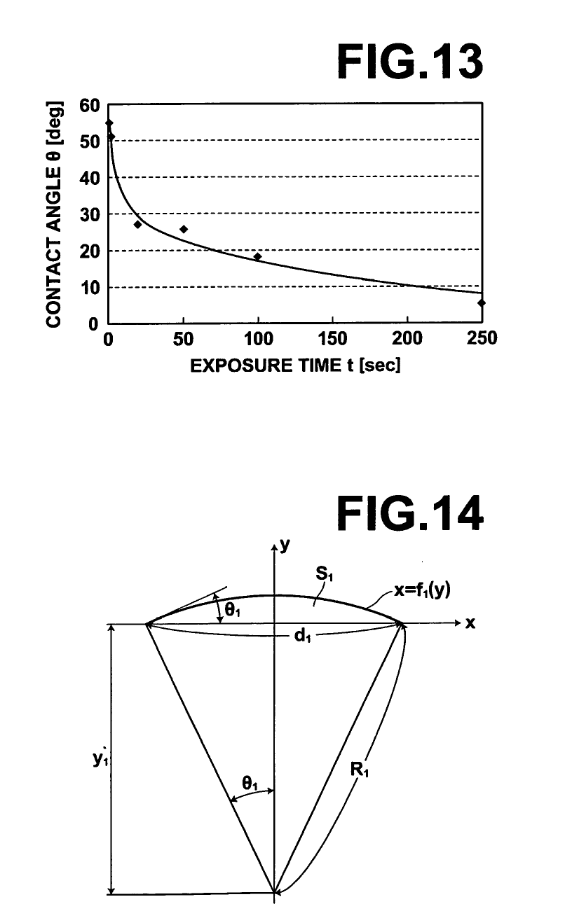

FIG. 13 shows the results of the measurement. In FIG. 13, the abscissa axis indicates the exposure time t [sec] and the ordinate axis indicates the contact angle θ [deg]. As can be seen from FIG. 13, the contact angle between the deposited transparent material and the cured film sample of the transparent material is changed by changing the exposure time. That is, the contact angle between the deposited transparent material and the previously cured transparent material varies depending on the exposure time. Specifically, it can be seen that the contact angle varies in the range from 5 to 55 degrees depending on the exposure time.

By measuring the relationship between the contact angle and the exposure time, as shown in FIG. 13, for various exposure conditions or for various transparent materials to be used, and storing the measured relationships in the control unit 6, the contact angle can be derived from various conditions.

Next, calculation of the minimum dot pitch pₘᵢₙ and the maximum dot pitch pₘₐₓ defining the dot pitch p is described. First, calculation of the minimum dot pitch pₘᵢₙ is described.

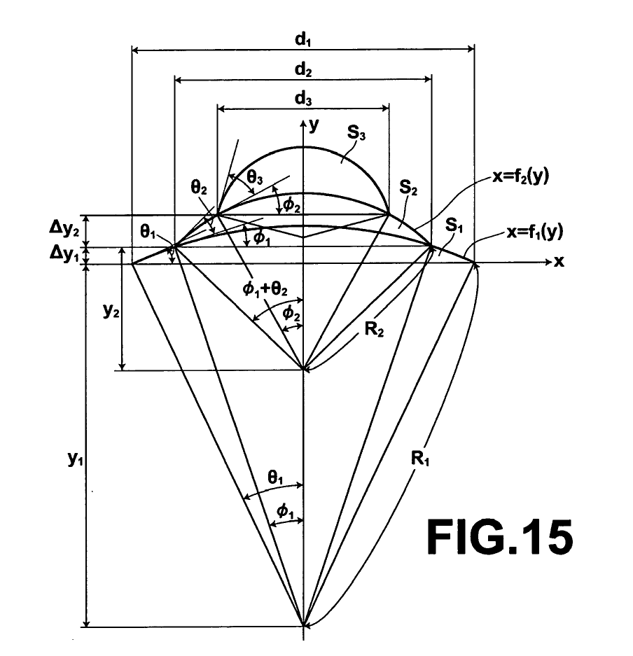

FIG. 14 is a schematic diagram illustrating the sectional shape of the pattern formed by depositing the transparent material on the image-recorded member, and FIG. 15 is a schematic diagram illustrates the sectional shape of the pattern formed by depositing the transparent material on the previously cured transparent material.

First, the shape of the transparent material which landed on the image-recorded member 11 (i.e., the transparent material which directly lands on the image-recorded member 11, and which may hereinafter be referred to as the “first transparent material”) is modeled with a segment of a sphere having a radius of curvature R₁, as shown in FIG. 14. It should be noted that the x-axis (the axis parallel to the image-recorded member 11) and the y-axis (the axis perpendicular to the image-recorded member 11 and crossing the center of the transparent material) shown in FIG. 14, with the center of a contact surface between the transparent material and the image-recorded member 11 being the origin, are axes on this model and are different from the x-direction and the y-direction shown in FIG. 1.

The modeled first transparent material has a line width d₁, a contact angle θ₁ between the image-recorded member 11 and the first transparent material, a sectional area S₁, and a distance y₁ from the center of the sphere forming the surface of the transparent material to the image-recorded member 11. The sectional shape profile of the first transparent material is expressed by Equation (1) below:

x=±\sqrt{R₁²−(y₁+y₁)²}, and y₁≧0 (1)

The y₁ and R₁ in Equation (1) are respectively expressed by Equations (2) below:

$${y}_{1} = \frac{{d}_{1}}{2 tan {θ}_{1}} , {R}_{1} = \frac{{d}_{1}}{2 sin {θ}_{1}} \qquad ( 2 )$$

From the above equations, the sectional area S₁ can be expressed by Equation (3) below:

$$\begin{matrix}{S}_{1} = {\int }_{- \frac{1}{2} {d}_{1}}^{\frac{1}{2} {d}_{1}} f ( x ) d x \\ = 2 ( π {R}_{1}^{2} {θ}_{1} - \frac{1}{4} {d}_{1} {y}_{1} ) \\ = 2 ( π \frac{{d}_{1}^{2}}{4 {sin}^{2} {θ}_{1}} {θ}_{1} - \frac{1}{4} {d}_{1} \frac{{d}_{1}}{2 tan {θ}_{1}} ) \\ = {d}_{1}^{2} ( π \frac{{θ}_{1}}{2 {sin}^{2} {θ}_{1}} - \frac{1}{4 tan {θ}_{1}} )\end{matrix} \qquad ( 3 )$$

As shown above, the sectional area S₁ is a function of the line width d₁ and the contact angle θ₁.

Then, as shown in FIG. 15, a state where the transparent material is deposited on the previously cured transparent material is modeled. It should be noted that, although FIG. 15 shows a case where three layers of the transparent material are formed on the image-recorded member 11, explanation is given in the following description on a case where the n-th transparent material is deposited on previously formed n−1 layers of the transparent material. That is, after the n−1-th transparent material has been cured, the n-th transparent material is deposited.

First, modeling the n-th transparent material deposited and landed on the cured n−1-th transparent material with an arc shape, the sectional shape profile of the n-th transparent material can be expressed by Equation (4) below:

$${f}_{n} ( x ) = \pm \sqrt{{R}_{n}^{2} - {x}^{2}} - {y}_{n} + {\sum }_{k = 1}^{n - 1} Δ {y}_{k} \qquad ( 4 )$$

The yₙ, Δyₖ and Rₙ in Equation (4) can be expressed by Equations (5) to (7) below, respectively. It should be noted that Φₙ₋₁ is an angle between a tangential line to the surface of the n−1-th transparent material and a plane parallel to the surface of the image-recorded member 11 at a tangent point between the surface of the n-th transparent material and the n−1-th transparent material, and can be expressed by Equation (8) below.

$$\begin{matrix}{y}_{n} = \frac{{d}_{n}}{2 tan ( {φ}_{n - 1} + {θ}_{n} )} & ( 5 ) \\ Δ {y}_{k} = {R}_{k} cos {φ}_{k} - {y}_{k} & ( 6 ) \\ {R}_{n} = \frac{{d}_{n}}{2 sin ( {φ}_{n - 1} + {θ}_{n} )} & ( 7 ) \\ {φ}_{n - 1} = {sin}^{- 1} \frac{{d}_{n}}{2 {R}_{n - 1}} & ( 8 )\end{matrix}$$

Using the relationships of Equations (4) to (8) above, a sectional area Sₙ can be expressed by Equation (9) below:

$$\begin{matrix}{S}_{n} = 2 {\int }_{0}^{{d}_{n} / 2} ( {f}_{n} - {f}_{n - 1} ) d x \\ = [ ( {φ}_{n - 1} + {θ}_{n} ) \frac{{d}_{n}}{2 sin ( {φ}_{n - 1} + {θ}_{n} )} - \\ \{ \begin{matrix}( {φ}_{n - 2} + {θ}_{n - 1} ) \frac{{d}_{n - 1}}{2 sin ( {φ}_{n - 2} + {θ}_{n - 1} )} - \\ \frac{{d}_{n}}{4} ( \begin{matrix}\frac{{d}_{n - 1}}{tan ( {φ}_{n - 2} + {θ}_{n - 1} )} - \\ \frac{{d}_{n}}{tan ( {φ}_{n - 1} + {θ}_{n} )}\end{matrix} )\end{matrix} \} ]\end{matrix} \qquad ( 9 )$$

As shown in Equation (9), the sectional area Sₙ can be expressed with the dₙ, dₙ₋₁, θₙ, θₙ₋₁ and Φₙ₋₁. The shape of the pattern formed by the n−1-th transparent material can be expressed with the dₙ₋₁ and Φₙ₋₁ in Equation (9). The θₙ and θₙ₋₁ are contact angles. Therefore, the sectional area Sₙ is calculated based on the contact angles and the shape of the pattern formed by the n−1-th transparent material.

Since the dₙ₋₁, θₙ₋₁ and Φₙ₋₁ are values relating to the n−1-th transparent material, they have been determined when the n-th transparent material is to be deposited. Further, the physical properties of the transparent material to be deposited as the n-th transparent material, and the physical properties and the curing conditions of the n−1-th transparent material have been determined when the n-th transparent material is to be deposited. Therefore, θₙ has been determined when the n-th transparent material is to be deposited. Thus, when the n-th transparent material is to be deposited, variables in Equation (9) are only dₙ and Sₙ.

Using Equation (9), a sectional area S (dₙ=dₙ₋₁) indicating the maximum deposition amount of the n-th transparent material to be deposited which achieves dₙ=dₙ₋₁ can be calculated. Assuming that the deposition amount of the transparent material to be deposited is V, p·Sₙ=V in a range where the dot pitch p≦pₘₐₓ. The minimum dot pitch pₘᵢₙ for ensuring that the transparent material to be deposited does not run off the edge of the underlying layer is therefore calculated according to Equation (10) below:

$${p}_{min} = \frac{V}{{S}_{n} ( {d}_{n} = {d}_{n - 1} )} \qquad ( 10 )$$

Next, calculation of the maximum dot pitch pₘₐₓ is described. It is disclosed in “The Impact and Spreading of Ink Jet Printed Droplets”, J. Stringer and B. Derby, Digital Fabrication, pp. 128-130, 2006, that, when a volume of the transparent material per droplet is not more than a line volume that is required to form a line between adjacent dots per dot pitch, jaggies are produced. Assuming that a dot diameter of the n-th transparent material spreading over the n−1-th transparent material is d_{dot}, a sectional area S (dₙ=d_{dot}) indicating the minimum amount of the n-th transparent material to be deposited which achieves dₙ=d_{dot} can be calculated. Assuming that the deposition amount of the transparent material to be deposited per droplet is V, p·Sₙ=V in a range where the dot pitch p≦pₘₐₓ. The maximum dot pitch pₘₐₓ is therefore calculated according to Equation (11) below:

$${p}_{max} = \frac{V}{{S}_{n} ( {d}_{n} = {d}_{dot} )} \qquad ( 11 )$$

Therefore; the control unit 6 calculates the dot pitch p to satisfy the relationship below:

$${p}_{min} \leq p \leq {p}_{max} , i . e . , \\ \frac{V}{{S}_{n} ( {d}_{n} = {d}_{n - 1} )} \leq p \leq \frac{V}{{S}_{n} ( {d}_{n} = {d}_{dot} )}$$

By depositing the transparent material at the thus calculated dot pitch p, the transparent material can be deposited on the previously cured transparent material without running off the edge of the previously cured transparent material and without forming jaggies.

Further, by calculating the sectional area Sₙ using Equation (9) with assuming that dₙ=dₙ₋₁, and calculating the minimum dot pitch pₘᵢₙ using Equation (10), the amount of the transparent material to be deposited per droplet can be maximized without the deposited transparent material running off the edge of the previously cured transparent material, that is, the maximum amount of the transparent material can be deposited without the deposited transparent material running off the edge of the previously cured transparent material.

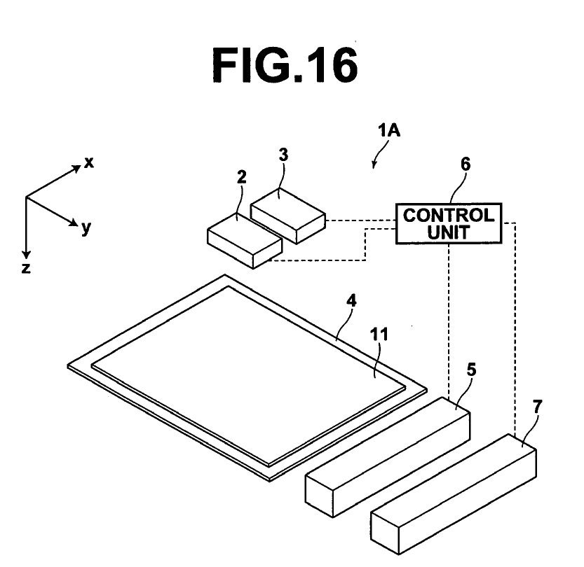

Next, a second embodiment of the invention is described. FIG. 16 is a schematic perspective view illustrating the structure of an inkjet recording device used in a method for forming a lenticular print according to the second embodiment of the invention. It should be noted that components in the second embodiment which are the same as those in the first embodiment are denoted by the same reference numerals and detailed explanations thereof are omitted. The inkjet recording device 1A according to the second embodiment differs from the inkjet recording device of the first embodiment in that the inkjet recording device 1A employs an inkjet head of an electrostatic inkjet system as the first head 2, and further includes a heating unit 7.

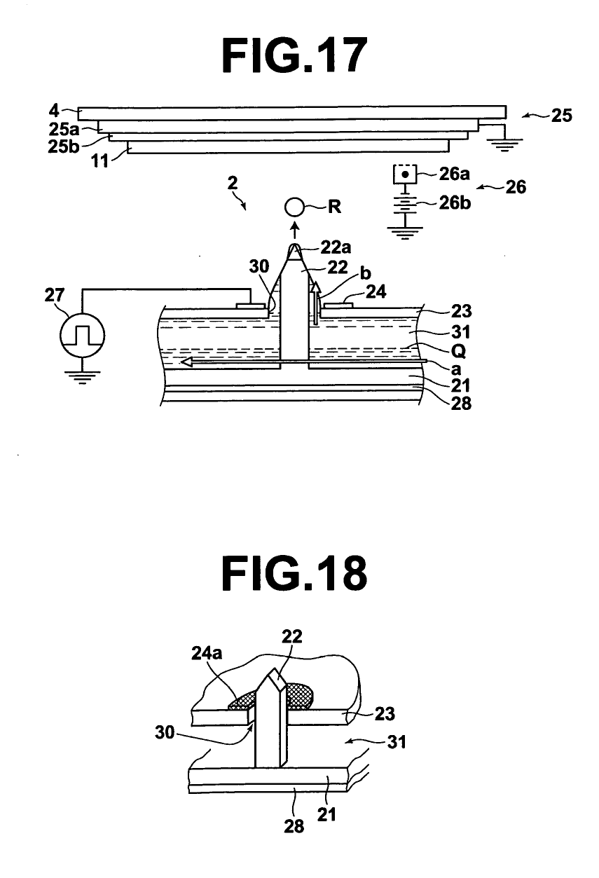

Now, the structure of the first head 2 of the second embodiment is described. FIG. 17 is a schematic sectional view illustrating the schematic structure of the first head 2 of the electrostatic inkjet system. It should be noted that the head 2 and the supporting plate 4 are shown upside-down in FIG. 17 with respect to those shown in FIG. 16 for convenience of explanation. As shown in FIG. 17, the head 2 ejects with an electrostatic force a transparent material Q containing a charged particulate component to deposit the transparent material Q on the image-recorded member 11. The head 2 includes a head substrate 21, a guide 22, an insulating substrate 23, an ejection electrode 24, an opposite electrode 25 attached on the supporting plate 4, a charging unit 26 for charging the image-recorded member 11, a signal voltage source 27 and a floating conductive plate 28.

The example shown in FIG. 17 is a conceptual expression of an individual electrode serving as a nozzle forming the first head 2. Although only one individual electrode (hereinafter referred to as a nozzle) is shown in FIG. 17, more than one nozzles may be provided, and there is no limitation in physical arrangement of the nozzles when there are more than one nozzles. For example, a plurality of nozzles may be arranged one-dimensionally or two-dimensionally to form a line head.

In the first head 2 shown in FIG. 17, the guide 22 is formed of a flat insulating resin plate having a predetermined thickness, and includes a pointed distal portion 22a. The guide 22 is provided on the head substrate 21 for each nozzle. The insulating substrate 23 includes a through hole 30 provided at a position corresponding to the position of the guide 22. The guide 22 passes through the through hole 30 provided in the insulating substrate 23 and the distal portion 22a projects upward from the upper surface, as in the drawing, of the insulating substrate 23. It should be noted that the guide 22 may include, at the center thereof, a notch in the vertical direction as in the drawing, which serves as a guiding groove for collecting the transparent material Q to the distal portion 22a with capillary action.

The distal portion 22a of the guide 22 is tapered toward the supporting plate 4 so that it forms a substantially triangular (or trapezoidal) shape. It should be noted that the distal portion (leading edge portion) 22a of the guide 22, from which the transparent material Q is ejected, may be coated with a metal through vapor deposition. Although the distal portion 22a of the guide 22 may not have the deposited metal, the deposited metal provides substantially infinite permittivity at the distal portion 22a of the guide 22, thereby promoting generation of an intense electric field. The shape of the guide 22 is not particularly limited as long as the transparent material Q, in particular, the charged particulate component of the transparent material Q can be concentrated at the distal portion 22a through the through hole 30 of the insulating substrate 23. For example, the shape of the distal portion 22a may be altered as appropriate, such as to a shape which is not pointed, or the distal portion 22a may have any known shape.

The head substrate 21 and the insulating substrate 23 are spaced apart from each other by a predetermined distance to form a channel 31 therebetween, which serves as a reservoir for supplying the transparent material Q to the guide 22. It should be noted that the transparent material Q in the channel 31 contains the particulate component, which is charged in the same polarity as the polarity of the voltage applied to the ejection electrode 24. During deposition, the transparent material Q is circulated in the channel 31 by a circulating mechanism (not shown) in a predetermined direction (in the illustrated example, from the right to the left) at a predetermined speed (for example, at a flow rate of 200 mm/s). In the following description, it is assumed that particles in the transparent material are positively charged, as an example.

As shown in FIG. 18, for each nozzle, the ejection electrode 24 in the form of a ring, i.e., a circular electrode 24a is disposed on the upper surface, as in the drawing, of the insulating substrate 23 to surround the through hole 30 in the insulating substrate 23. The ejection electrode 24 is connected to the signal voltage source 27, which generates pulse signals (of predetermined pulse voltages, such as one having a low voltage level of 0 V and one having a high voltage level of 400-600 V) according to ejection timing of the transparent material.

It should be noted that the shape of the ejection electrode 24 is not limited to the ring-shaped circular electrode 24a shown in FIG. 18. The ejection electrode 24 may have any shape as long as it is a surrounding electrode which is disposed to surround and to be spaced apart from the outer periphery of the guide 22, or parallel electrodes which are disposed at opposite sides of the guide 22 to face to each other and to be spaced apart from the guide 22. If the ejection electrode 24 is a surrounding electrode, for example, the ejection electrode 24 may be a substantially circular electrode, or may be a circular electrode as shown in FIG. 18. If the ejection electrode 24 is parallel electrodes, the ejection electrode 24 may be substantially parallel electrodes. In the following description, the ring-shaped circular electrode 24a shown in FIG. 18 is used, which is a representative example of the surrounding electrode.

The opposite electrode 25 is supported by the supporting plate 4 to be positioned to face the distal portion 22a of the guide 22. The opposite electrode 25 includes an electrode substrate 25a and an insulating sheet 25b, which is disposed on the lower surface, as in the drawing, of the electrode substrate 25a, i.e., the surface of the electrode substrate 25a facing the guide 22. The electrode substrate 25a is grounded. The image-recorded member 11 is supported on the surface of the insulating sheet 25b of the opposite electrode 25 through electrostatic adsorption, for example, and thus the opposite electrode 25 (the insulating sheet 25b) serves as a platen for the image-recorded member 11.

At least during deposition of the transparent material, the charging unit 26 maintains the charge on the surface of the insulating sheet 25b of the opposite electrode 25, and in turn on the image-recorded member 11, at a predetermined high negative voltage (−1500V, for example) of opposite polarity from the polarity of the high voltage (pulse voltage) applied to the ejection electrode 24. As a result, the image-recorded member 11 negatively charged by the charging unit 26 is always biased with the high negative voltage with respect to the ejection voltage and is electrostatically adsorbed on the insulating sheet 25b of the opposite electrode 25.

The charging unit 26 includes a scorotron charger 26a for charging the image-recorded member 11 with the high negative voltage, and a bias voltage source 26b for supplying the high negative voltage to the scorotron charger 26a. It should be noted that the charging means of the charging unit 26 used in this embodiment is not limited to the scorotron charger 26a, and any of various discharging means, such as a corotron charger, a solid-state charger or a discharge pin, may be used.

In the example shown in FIG. 17, the opposite electrode 25 is formed by the electrode substrate 25a and the insulating sheet 25b, and the image-recorded member 11 is charged by the charging unit 26 with the high negative voltage so that the image-recorded member 11 is electrostatically adsorbed on the surface of the insulating sheet 25b. Alternatively, the opposite electrode 25 may be formed only by the electrode substrate 25a, and the opposite electrode 25 (the electrode substrate 25a itself) may be connected to the bias voltage source for supplying the high negative voltage so that the opposite electrode 25 is always biased with the high negative voltage and the image-recorded member 11 is electrostatically adsorbed on the surface of the opposite electrode 25.

The electrostatic adsorption of the image-recorded member 11 onto the opposite electrode 25 and the charging of the image-recorded member 11 with the high negative voltage or the application of the high negative bias voltage to the opposite electrode 25 may be achieved using separate high negative voltage sources. Further, the manner of the support of the image-recorded member 11 by the opposite electrode 25 is not limited to the electrostatic adsorption, and any other supporting method or supporting means may be used.

The floating conductive plate 28 is disposed below the channel 31 and is electrically insulated (has high impedance). In FIG. 18, the floating conductive plate 28 is disposed at the inner side of the head substrate 21. It should be noted that, in this embodiment, the floating conductive plate 28 may be disposed at any position as long as it is disposed below the channel 31. For example, the floating conductive plate 28 may be disposed below the head substrate 21, or may be disposed upstream from the position of the individual electrode along the channel 31 and at the inner side of the head substrate 21.

During deposition of the transparent material, the floating conductive plate 28 causes an induced voltage to be induced depending on the value of the voltage applied to the individual electrode, so that the particulate component of the transparent material Q in the channel 31 migrates toward the insulating substrate 23 and concentrates there. Therefore, the floating conductive plate 28 needs to be disposed on the side of the channel 31 where the head substrate 21 is present. The floating conductive plate 28 may optionally be disposed upstream from the position of the individual electrode along the channel 31. Since the floating conductive plate 28 serves to increase the concentration of the charged particulate component at the upper layer of the transparent material Q in the channel 31, the concentration of the charged particulate component of the transparent material Q passing through the through hole 30 of the insulating substrate 23 can be increased to a predetermined concentration. Thus, the charged particulate component of the transparent material Q can be concentrated at the distal portion 22a of the guide 22, thereby allowing stabilizing the predetermined concentration of the charged particulate component of the transparent material Q to be ejected of as a droplet R.

With the floating conductive plate 28 provided, the induced voltage is varied depending on the number of operating channels. Therefore, the charged particles necessary for ejection can be supplied without controlling the voltage applied to the floating conductive plate, and thus clogging can be prevented. It should be noted that a power source may be connected to the floating conductive plate to apply a predetermined voltage thereto.

The structure of the first head 2 used in the second embodiment is as described above. Now, operation of the first head 2 during deposition of the transparent material in the second embodiment is described.

In the first head 2 shown in FIG. 17, during deposition of the transparent material, the transparent material Q containing the particulate component, which is charged in the same polarity (for example, positive (+)) as the polarity of the voltage applied to the ejection electrode 24, is circulated in the channel 31 in the direction of arrow A, i.e., from the right to the left in FIG. 17, by the transparent material circulate mechanism (not shown) including a pump, or the like. At this time, the image-recorded member 11, which is electrostatically adsorbed on the opposite electrode 25, is charged in the opposite polarity, i.e., the high negative voltage (−1500 V, for example). The floating conductive plate 26 is insulated (has high impedance).

When the pulse voltage is not applied to the ejection electrode 24 or the applied pulse voltage is at the low voltage level (0 V), a voltage (potential difference) between the ejection electrode 24 and the opposite electrode 25 (the image-recorded member 11) is, for example, 1500 V which corresponds to the bias voltage. In this state, intensity of the electric field in the vicinity of the distal portion 22a of the guide 22 is low, and the transparent material Q is not ejected as the droplet R from the distal portion 2a of the guide 22. At this time, a part of the transparent material Q in the channel 31, in particular, the charged particulate component contained in the transparent material Q passes through the through hole 30 of the insulating substrate 23 and moves up in the direction of arrow b in FIG. 17, i.e., in the direction from the lower side to the upper side of the insulating substrate 23, due to electrophoretic migration and capillary action, to be supplied to the distal portion 22a of the guide 22.

On the other hand, when the pulse voltage at the high voltage level (400-600 V, for example) is applied to the ejection electrode 24, the voltage (potential difference) between the ejection electrode 24 and the opposite electrode 25 (the image-recorded member 11) is, for example, as high as 1900-2100 V, which is 1500 V corresponding to the bias voltage plus 400-600 V corresponding to the pulse voltage, and thus the intensity of the electric field in the vicinity of the distal portion 22a of the guide 22 is increased. At this time, the transparent material Q, in particular, the charged particulate component concentrated in the transparent material Q, which has moved up along the guide 22 to the distal portion 22a above the insulating substrate 23, is ejected as the droplet R containing the charged particulate component from the distal portion 22a of the guide 22 due to the electrostatic force. The ejected droplet R is attracted to the opposite electrode 25 (the image-recorded member 11), which is biased to −1500 V, for example, and is deposited on the image-recorded member 11.

As described above, by depositing the transparent material to form the layers one on the other while moving the first head 2 and the image-recorded member 11 supported on the opposite electrode 25 relatively to each other, the bases 13 can be formed on the image-recorded member 11.

During formation of the bases 13, the heating unit 7 heats the image-recorded member 11, on which the transparent material is deposited from the first head 2, to heat the deposited transparent material. That is, the particulate component contained in the transparent material is melted by the heat, and then is cured to form the bases 13. It should be noted that, similarly to the exposure mechanism 5, the heating unit 7 is disposed to cover an area across the support plate 4 in the x-direction shown in FIG. 16.

As the heating unit 7, any device that can heat the transparent material may be used, and an example thereof may be an infrared lamp or a heater. It should be noted that the intensity of the heat can be adjusted by changing the intensity of the voltage applied to the heating unit, such as an infrared lamp or a heater.

In the second embodiment, the transparent material is deposited from the first head 2 of the electrostatic inkjet system onto the image-recorded member 11, similarly to the first embodiment. Then, instead of being exposed to light by the exposure mechanism 5, the deposited transparent material is heated by the heating unit 7 to melt the particulate component contained in the transparent material, and then, the heat is stopped to cure the transparent material. The operations to deposit the transparent material on the previously cured transparent material and to cure the deposited transparent material are repeated to complete the bases 13.

It should be noted that formation of the lens top portions in the second embodiment is achieved similarly to the above-described first embodiment by repeating the steps of deposition and curing of the transparent material using the exposure mechanism 5.

As described above, in the second embodiment, the inkjet head of the electrostatic inkjet system is used as the first head 2. Among various inkjet systems, the electrostatic inkjet system can eject the concentrated solid content and the particles contained in the transparent material are self-assembled due to the liquid-bridging force when the solvent is dried off. Therefore, when the first head 2 is formed by the inkjet head of the electrostatic concentration inkjet system, the transparent material to form the bases 13 can be prevented from spreading when it is still wet. This allows accurate formation of the bases 13 having a rectangular sectional shape.

Next, a third embodiment of the invention is described. It should be noted that an inkjet recording device used in a method for forming a lenticular print according to the third embodiment has the same structure as the inkjet recording device used in the first embodiment described above, and only the operation carried out by the inkjet recording device is different. Therefore, detailed explanation of the structure of the inkjet recording device of this embodiment is omitted. In the third embodiment, each of the first and second heads 2 and 3 includes more than one nozzles, so that more than one bases 13 and more than one lens top portions 14 are formed respectively at a time using more than one nozzles.

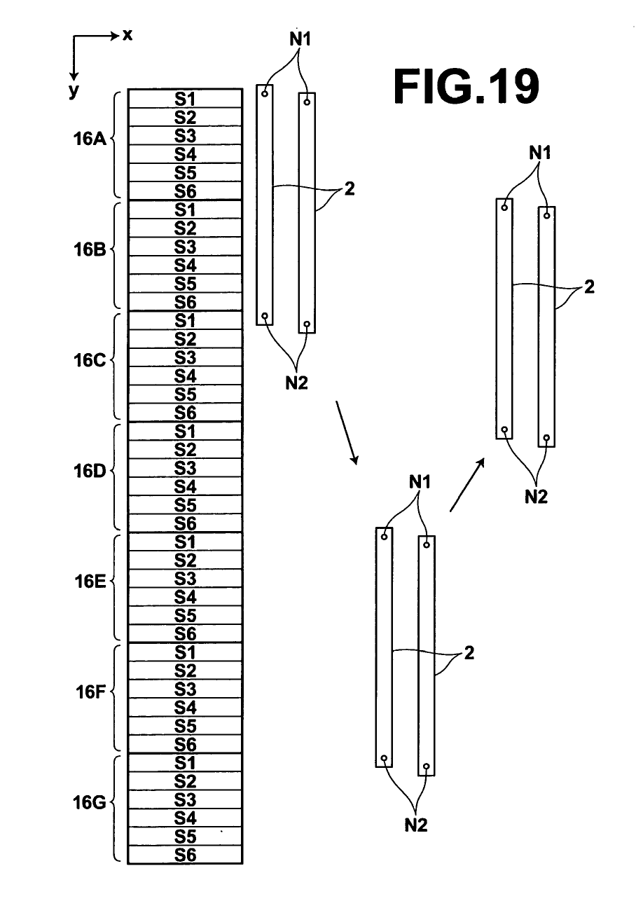

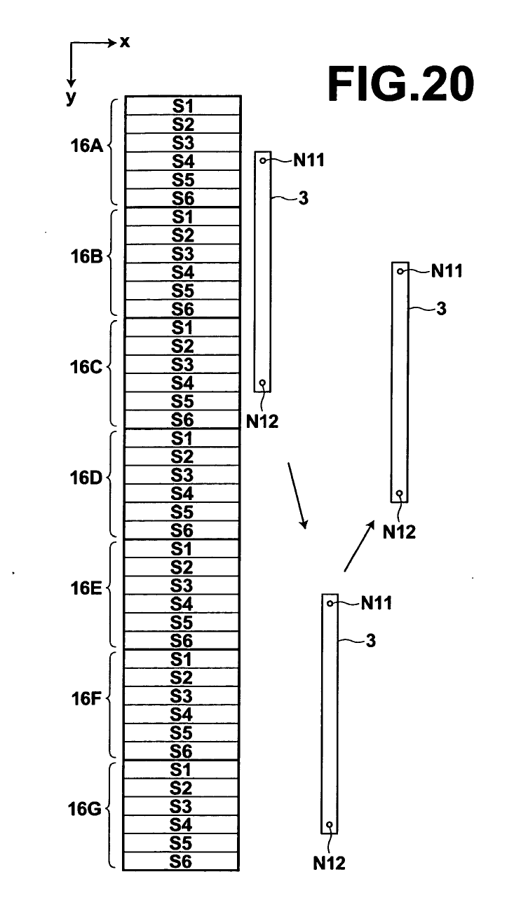

FIG. 19 is a diagram for explaining scanning by the first head 2 in the third embodiment, and FIG. 20 is a diagram for explaining scanning by the second head 3 in the third embodiment. It should be noted that the scale in the longitudinal direction of the parallax images shown in FIGS. 19 and 20 is reduced for convenience of explanation. FIGS. 19 and 20 respectively show seven areas 16A to 16G where the lenses are formed, and each area contains a group of parallax images including six parallax images (parallax image strips) S1 to S6. Only two nozzles N1 and N2 in the first head 2 for ejecting the transparent material are shown in FIG. 19, and only two nozzles N11 and N12 in the second head 3 for ejecting the transparent material are shown in FIG. 20.

In the third embodiment, the bases 13 corresponding to adjacent two of the lenses 12 are formed using the same nozzle, and the lens top portions 14 corresponding to the adjacent two lenses 12 are formed using the same nozzle. Specifically, for the areas 16A and 16B shown in FIG. 19, the bases 13 are formed by the nozzle N1 of the first head 2, and for the areas 16C and 16D, the bases 13 are formed by the nozzle N2 of the first head 2. For the areas 16A and 16B shown in FIG. 20, the lens top portions 14 are formed by the nozzle N11 of the second head 3, and for the areas 16C and 16D, the lens top portions 14 are formed by the nozzle N12 of the second head 3.

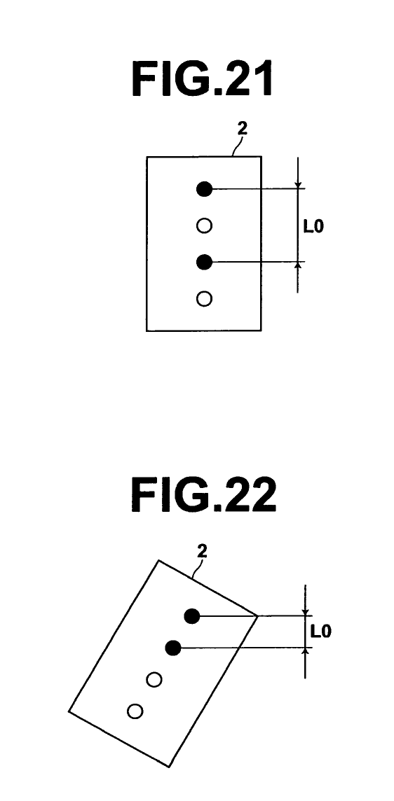

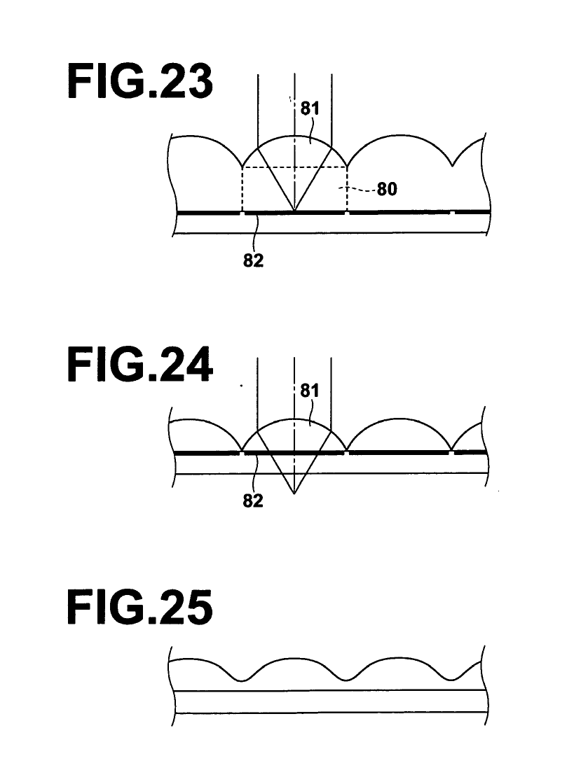

It should be noted that, in the first head 2, the nozzles ejecting the transparent material are controlled such that a distance between the nozzles N1 and N2 ejecting the transparent material is equivalent to the width (L0) of two areas. For example, in a case where the nozzles are two-dimensionally arrayed, as shown in FIG. 21, the nozzles ejecting the transparent material are set such that the distance between the nozzles in a direction in which the member 11 to be scanned moves is equivalent to the width L0 of two areas. In this case, if necessary, the head 2 is rotated, as shown in FIG. 22, to make the distance between the nozzles ejecting the transparent material in the direction in which the member 11 to be scanned moves be equal to the width L0 of two areas. For example, assuming that the two nozzles shown as black circles in FIG. 22 are used, and the distance between the nozzles is 800 μm and the width L0 is 508 μm, the head 2 is rotated to achieve the distance of 508 μm between the two nozzles.

Similarly, the nozzles of the second head 3 ejecting the transparent material may be controlled and/or the second head 3 may be rotated to make the distance between the nozzles N11 and N12 ejecting the transparent material equal to the width L0 of two areas.

Next, operation of the first head 2 in the third embodiment is described. Setting of the deposition conditions and alignment are carried out in the same manner as in the first embodiment. Similarly to the above-described first embodiment, formation of the bases 13 is carried out at different times for adjacent groups of the groups of parallax images. First, the control unit 6 causes the nozzle N1 to deposit the transparent material at a position corresponding to an end portion of the parallax image S1 in the area 16A and the nozzle N2 to deposit the transparent material at a position corresponding to an end portion of the parallax image S1 in the area 16C, as shown in FIG. 19, while the first head 2 is moved in the x-direction.

The control unit 6 moves the first head 2 across the image-recorded member 11 to deposit the transparent material with the nozzles N1 and N2 across the areas on the image-recorded member 11 facing the first head 2 being moved, and then, moves the image-recorded member 11 by a distance corresponding to one dot of the deposited transparent material in the y-direction so that head 2 can deposit the transparent material on a position adjacent to the previously deposited transparent material.

In this manner, the deposition of the transparent material by the first head 2 and the movement of the image-recorded member 11 by the distance corresponding to one dot are repeated to deposit the transparent material throughout the areas 16A and 16C. After the transparent material has been deposited throughout the areas 16A and 16C, the control unit 6 moves the image recorded member 11 in the y-direction by a predetermined distance so that the next groups of parallax images face the first head 2. Specifically, the image-recorded member 11 is moved so that each of the nozzles N1 and N2 faces and end portion of the parallax image S1 in each of the areas 16E and 16G, which are at positions respectively apart from the areas 16A and 16C by a distance corresponding to three areas. Then, the transparent material is deposited on the areas 16E and 16G.

Then, the deposition of the transparent material by the first head 2 and the movement of the image-recorded member 11 by the predetermined distance are repeated to deposit the transparent material throughout the image-recorded member 11. In the third embodiment, after the transparent material has been deposited on one area with each of the nozzles N1 and N2, the image recorded member 11 is moved so that areas respectively apart from the previous areas by a distance corresponding to three areas face the nozzles N1 and N2, thereby depositing the transparent material alternately on every other area. When the transparent material has been deposited throughout the image recorded member 11, the deposited transparent material is cured. The operations to deposit and cure the transparent material are repeated, similarly to the first embodiment, to form the bases 13 alternately on every other area on the image recorded member 11.

Next, operation of the second head 3 in the third embodiment is described. Setting of the deposition conditions and alignment are carried out in the same manner as in the first embodiment. First, the control unit 6 causes the nozzle N11 to deposit the transparent material on the previously formed base 13 in the area 16A and the nozzle N12 to deposit the transparent material on the previously formed base 13 in the area 16C, as shown in FIG. 20, while the second head 3 is moved in the x-direction.

The control unit 6 moves the second head 3 across the image-recorded member 11 to deposit the transparent material with the nozzles N11 and N12 across the areas on the image-recorded member 11 facing the head 3 being moved, i.e., across the bases 13 formed in the areas 16A and 16C, and then moves the image-recorded member 11 by a predetermined distance in the y-direction so that the next groups of parallax images face the second head 3. Specifically, the image-recorded member 11 is moved so that the nozzles N11 and N12 respectively face the areas 16E and 16G, which are at positions respectively apart from the areas 16A and 16C by a distance corresponding to three areas. Then, the transparent material is deposit on the bases 13 formed in the areas 16E and 16G.

In this manner, the deposition of the transparent material by the second head 3 and the movement of the image-recorded member 11 by the predetermined distance are repeated to deposit the transparent material throughout the image-recorded member 11. In the third embodiment, after the transparent material has been deposited on one area with each of the nozzles N11 and N12, the image recorded member 11 is moved so that areas respectively apart from the previous areas by a distance corresponding to three areas face the nozzles N11 and N12, thereby depositing the transparent material alternately on every other area. That is, the transparent material is deposited on the previously formed bases 13. When the transparent material has been deposited throughout the image recorded member 11, the deposited transparent material is cured. The operations to deposit and cure the transparent material are repeated, similarly to the first embodiment, to form the lens top portions 14 alternately on every other area.

Subsequently, new bases 13 and new lens top portions 14 are formed between the lenses 12 formed by the previously formed bases 13 and the lens top portions 14. Formation of the new bases 13 and new lens top portions 14 is achieved by repeating the deposition of the transparent material from the first head 2 and the second head 3 between the previously formed lenses 12 and the curing of the deposited transparent material. Specifically, the transparent material is deposited and cured in the areas 16B, 16D and 16F shown in FIG. 19 to form the new bases 13, and then, the transparent material is deposited and cured on the newly formed bases 13 in the areas 16B, 16D and 16F to form the lens top portions 14. In this manner, the lenses 12 are formed correspondingly to the individual groups of parallax images on the image recorded member 11.

As described above, in the third embodiment, the bases 13 corresponding to adjacent two of the lenses 12 and the lens top portions 14 corresponding to the adjacent two of the lenses 12 are formed by depositing the materials using respectively the same nozzles, and therefore the adjacent two lenses 12 are formed with the nozzles having the same characteristics.

With respect to directional accuracy of ejection from an inkjet head, in general, although there is variation of ejection position error between nozzles of the head, each one nozzle has fixed ejection directionality due to the initial shape error of each nozzle section, and therefore landing positions do not randomly vary.

Therefore, by forming adjacent two of the lenses 12 by depositing the material from the nozzles having the same characteristics of the first and second heads 2 and 3 of the inkjet system, the adjacent two lenses 12 having the same characteristics are provided. This allows more successful stereoscopic viewing of the formed lenticular print.

It should be noted that, although adjacent two of the lenses 12 are formed with the same nozzles in the third embodiment described above, adjacent three or more of the lenticular lenses 12 may be formed with the same nozzles.

Further, in the first to third embodiments, after the bases 13 have been formed, a liquid-repellent treatment may be carried out. The liquid-repellent treatment may be achieved by any of various methods. For example, a fluororesin material, such as PTFE (polytetrafluoroethylene), may be coated through spin coating, vapor deposition, or the like, on the entire area of the image-recorded member 11 with the bases 13 formed thereon and may be dried to form a liquid-repellent surface on the surface of the image-recorded member 11 as well as the surfaces of the bases 13. Alternatively, plasma treatment may be used. Further alternatively, the liquid-repellent treatment may be achieved by using a method for treating a fluororesin disclosed in Japanese Unexamined Patent Publication No. 2000-017091, or a super water-repellent treatment disclosed in “Influence of Ar Ion Injection on Super Water Repellency of Fluororesin”, (Proceedings of the 15th Ion Injection Surface Treatment Symposium), for example. Further alternatively, a similar effect can be provided by adding a fluorosurfactant to the transparent material.

By applying the liquid-repellent treatment on the surface of the image-recorded member 11 after the bases 13 have been formed, surface tension of the transparent material deposited on the bases 13 to form the lens top portions 14 is increased. This prevents the transparent material from running off the edges of the bases 13, thereby allowing accurate formation of the lens top portions 14, and thus the lenses 12.

Whether or not the liquid-repellent treatment should be applied, or the degree of the liquid-repellent treatment may be determined as appropriate. By selectively applying the liquid-repellent treatment, a depositable amount of the transparent material can be controlled to control the curvature of the formed lens top portions 14.

What is claimed is:

1. A method for forming a lenticular print that allows stereoscopic viewing by forming lenticular lenses, each having a convex sectional shape, on an image-recorded member, the image-recorded member having groups of parallax images arranged and written thereon, each group of parallax images including strips of parallax images, and the lenticular lenses being formed at positions corresponding to the individual groups of parallax images, the method comprising:
a base forming step of forming bases of the lenticular lenses by depositing a transparent material on the groups of parallax images on the image-recorded member, the bases extending in a longitudinal direction of the parallax images and having a rectangular sectional shape and a predetermined height; and
a lens forming step of forming lens top portions of the lenticular lenses by depositing the transparent material on the bases, the deposited transparent material bulging upward from the bases due to surface tension thereof to have a substantially circular sectional shape.

2. The method for forming a lenticular print as claimed in claim 1, wherein the base forming step is carried out at different times for adjacent groups of the groups of parallax images and the lens forming step is carried out at different times for adjacent groups of the groups of parallax images.

3. The method for forming a lenticular print as claimed in claim 1, wherein the base forming step comprises forming the bases by depositing the transparent material on the groups of parallax images with an inkjet head for base.

4. The method for forming a lenticular print as claimed in claim 3, wherein the base forming step comprises:
a depositing step of depositing the transparent material on the groups of parallax images with the inkjet head for base, the transparent material being curable;
a curing step of curing the deposited transparent material; and
a laminating step of forming the bases by repeating operations of depositing a predetermined deposition amount of the transparent material on the cured transparent material and curing the deposited transparent material,
wherein the laminating step comprises depositing the transparent material to satisfy a relationship pₘᵢₙ≦p, where p is a dot pitch of the transparent material to be deposited and pₘᵢₙ is a minimum dot pitch for ensuring that the deposited transparent material does not run off an edge of a landing-position transparent material, the landing-position transparent material being the transparent material cured at a landing position of the transparent material to be deposited.

5. The method for forming a lenticular print as claimed in claim 3, wherein the inkjet head for base comprises an inkjet head of an electrostatic concentration inkjet system.

6. The method for forming a lenticular print as claimed in claim 3, wherein the base forming step comprises depositing the transparent material with moving the inkjet head for base and the image-recorded member relatively to each other in the longitudinal direction of the parallax images.

7. The method for forming a lenticular print as claimed in claim 3, wherein the base forming step comprises using a same nozzle of the inkjet head for base to deposit the transparent material to form the bases corresponding to at least two adjacent lenticular lenses.

8. The method for forming a lenticular print as claimed in claim 1, wherein the lens forming step comprises forming the lens top portions by depositing the transparent material on the bases with an inkjet head for lens top portion.

9. The method for forming a lenticular print as claimed in claim 8, wherein the lens forming step comprises using a same nozzle of the inkjet head for lens top portion to deposit the transparent material to form the lens top portions corresponding to at least two adjacent lenticular lenses.

10. The method for forming a lenticular print as claimed in claim 1, wherein the bases have a height equal to or greater than a radius of curvature of a portion of each lens top portion bulging upward from the base and having the substantially circular sectional shape.
